(19) United States
(12) Patent Application Publication
(10) Pub. No.: US 2023/0034257 A1
(43) Pub. Date: Feb. 2, 2023

(54) INDEXES OF VERTICAL TABLE COLUMNS HAVING A SUBSET OF ROWS CORRELATING TO A PARTITION RANGE

(71) Applicant: MICRO FOCUS LLC, SANTA CLARA, CA (US)

(72) Inventors: Yuanzhe BEI, Cambridge, MA (US); Pan YE, Cambridge, MA (US)

(73) Assignee: MICRO FOCUS LLC, SANTA CLARA, CA (US)

(21) Appl. No.: 17/387,893

(22) Filed: Jul. 28, 2021

(51) Int. Cl. G06F 16/22; G06F 16/2455

(52) U.S. Cl. CPC G06F 16/22; G06F 16/24553

(57) ABSTRACT

According to examples, an apparatus may include a processor and a memory on which are stored machine-readable instructions that when executed by the processor cause the processor to receive parameters for a partition range for a partition key associated with a table. The table may have a vertical table structure. The processor may generate an index of vertical table columns based on the received parameters for the partition range. The generated index may be a physical store for data from the table and may have a subset of rows of the table correlating to the partition range. The processor may receive a query having a predicate associated with the partition key associated with the table and, based on a determination that the predicate included in the received query is within a partition range for the generated index, the processor may execute the query using the generated index.

### BACKGROUND

Databases may be implemented to store data in tables having a column format or a row format. Different types of queries may be executed more efficiently using indexes having either the column format or the row format.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may receive parameters for a partition range for a partition key associated with a table, generate an index based on the received parameters for the partition range, and execute a query using the generated index based on a predicate associated with the partition key;

FIG. 2 shows a block diagram of an example system in which the example apparatus depicted in FIG. 1 may be implemented;

FIG. 3 shows a block diagram of example indexes associated with a table, the example indexes including an index that is partition ranged on a partition key associated with the table;

FIG. 4 shows a flow diagram of an example method for generating an index of vertical table columns based on a minimum value and a maximum value of a partition range for a partition key associated with a table, receiving a query having a predicate associated with the partition key, and executing the query using the generated index based on the predicate included in the query; and

FIG. 5 shows a block diagram of an example non-transitory computer-readable medium that may have stored thereon machine readable instructions to generate a projection having a partition range, receive a query having a predicate associated with a partition key, and execute the received query using the generated projection based on the predicate included in the received query.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Generally, a database management system (DBMS) may store data in tables having columns and rows. Databases that are columnar may store each column in a table as an object and may tend to be suitable for quickly and efficiently processing complex analytical queries, whereas row-based databases may store each row in a table as objects and may tend to be transactional databases. Databases that store data in a column format may enable faster query processing and reduced disk I/O when compared to row-based databases. In some examples, databases may have a set of tables and may store data in indexes correlated to the tables. In some examples, the databases may store data in super-projections and projections.

As used herein, the term “projections” may be regarded as being the same as indexes for tables and “super-projections” may be regarded as being the same as tables, Projections may be collections of table columns, and may physically store table data within the projections. A super-projection may include all columns of the table, whereas a projection, or a non-super-projection, may store select columns of the table.

In some examples, the projections may be optimized for specific queries, for instance, by sort order optimized for certain queries, or the like. While projections may provide enhanced query processing due to the optimization of projections to queries, for instance, by sorting or segmentation, the projections may store the entire range of rows of the super-projection. For instance, many queries may be based on newest data, and may be directed to data in the latest partitions or rows. As such, even though the projections may include a subset of the columns and may provide associated efficiencies in query processing, the presence of an entire range of rows in each of the projections may result in waste in storage resources and may complicate maintenance such as refresh operations.

Disclosed herein are methods, apparatuses, and computer-readable mediums that may allow a user to optionally specify a partition range for the projection, such that the projection may store data in that partition range, without storing data outside the partition range. A partition ranged projection as described herein may reduce wasted memory resources and may improve processor performance for query processing. In some examples, the processor may receive parameters for a partition range for a partition key associated with a table and may generate an index of vertical table columns based on the received parameters for the partition range. In some examples, the processor may receive a query having a predicate associated with the partition key associated with the table. Based on the predicate included in the received query, the processor may execute the query using the generated index among a plurality of indexes of vertical table columns for the table.

By enabling a processor to allow projections to be partition ranged, execution of queries by the processor may be improved when compared to using indexes or partitions that include all of the rows of a table. The partition ranged projections as described herein may also enhance efficiency of the processor based on performance improvements to refresh and maintain the projections, for instance, due to smaller containers associated with the partition ranged projections.

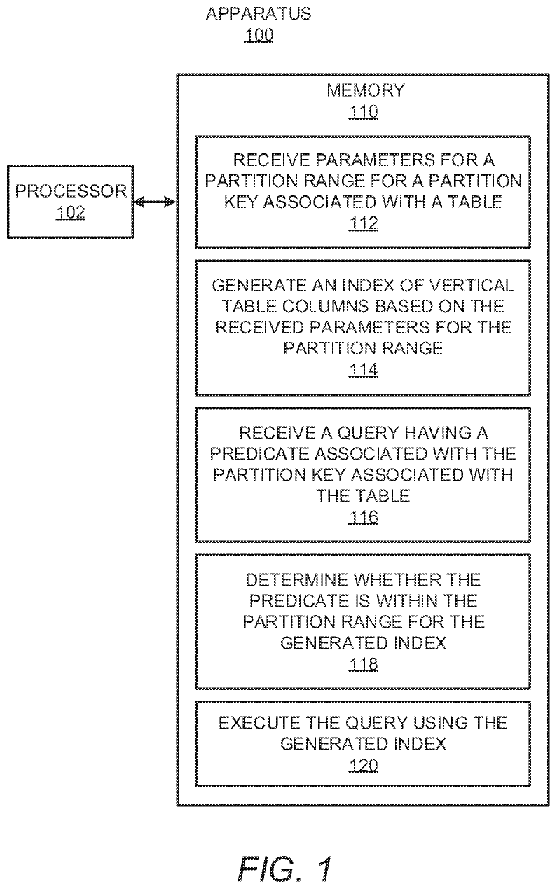

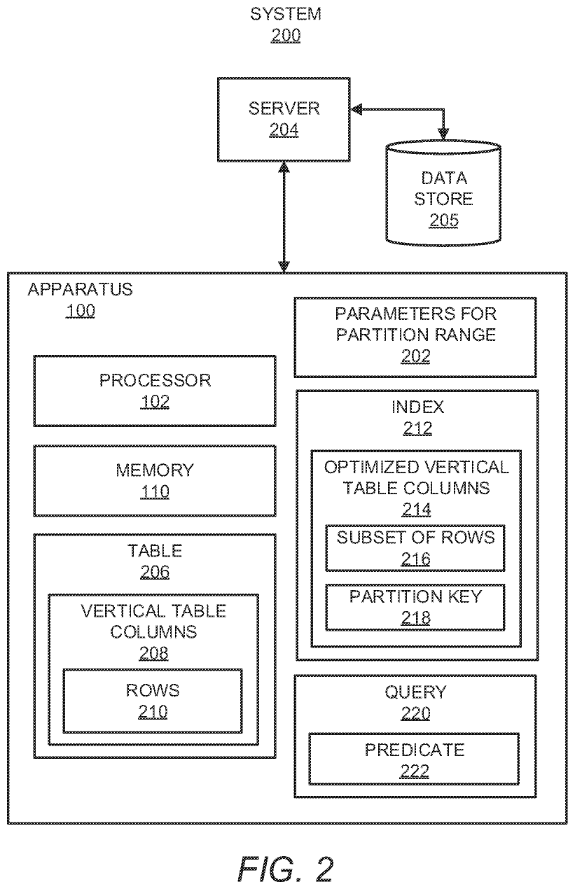

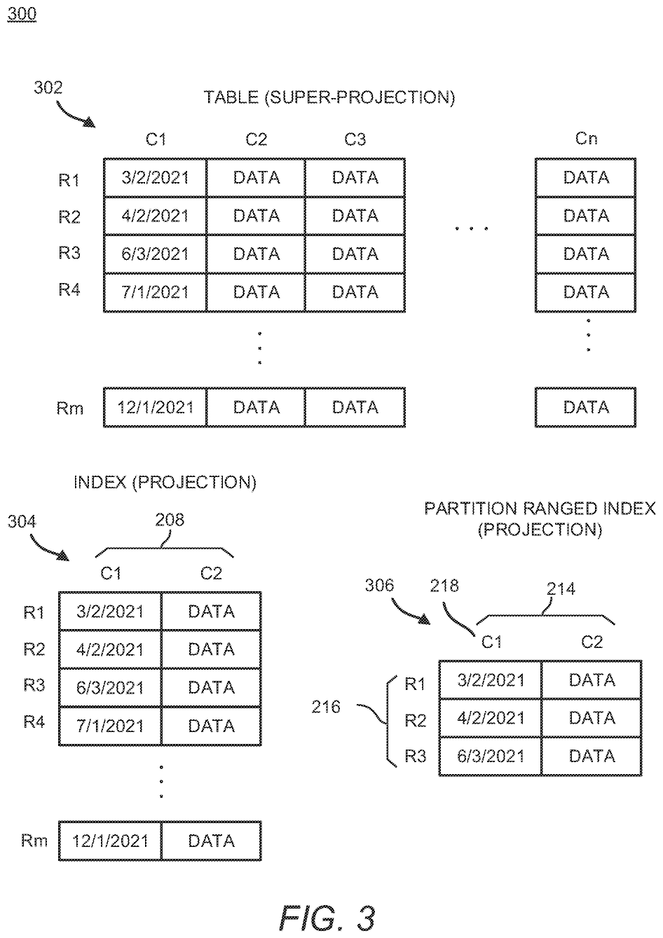

Reference is made to FIGS. 1, 2, and 3. FIG. 1 shows a block diagram of an example apparatus 100 that may receive parameters for a partition range for a partition key associated with a table, may generate an index based on the received parameters for the partition range, and may execute a query using the generated index based on a predicate associated with the partition key. FIG. 2 shows a block diagram of an example system 200 in which the example apparatus 100 depicted in FIG. 1 may be implemented. FIG. 3 shows a block diagram of example indexes 300 associated with a table, in which the example indexes 300 may include an index that may be partition ranged on a partition key associated with the table. It should be understood that the example apparatus 100 depicted in FIG. 1, the example system 200 depicted in FIG. 2, and the example indexes 300 depicted in FIG. 3 may include additional features and that some of the features described herein may be removed and/or modified without departing from the scopes of the apparatus 100, the system 200, and/or the indexes 300.

The apparatus 100 may be a server (such as a management server), a node in a network (such as a data center), a personal computer, a laptop computer, a tablet computer, a smartphone, and/or the like. As shown, the apparatus 100 may include a processor 102 and a memory 110, e.g., a non-transitory computer-readable medium. In some examples, the apparatus 100 may be a management server in a cloud-based management platform that has stored thereon instructions that may cause the processor 102 to execute discovery processes to discover network configuration information on multiple cloud platforms.

The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100. In this regard, references to a single processor 102 as well as to a single memory 110 may be understood to additionally or alternatively pertain to multiple processors 102 and/or multiple memories 110.

The memory 110 may be an electronic, magnetic, optical, or other physical storage device that contains or stores executable instructions. The memory 110 may be, for example, Read Only Memory (ROM), flash memory, solid state drive, Random Access memory (RAM), an Erasable Programmable Read-Only Memory (EPROM), an Electrically Erasable Programmable Read-Only Memory (EEPROM), a storage device, an optical disc, or the like. The memory 110 may be a non-transitory computer-readable medium. The term “non-transitory” does not encompass transitory propagating signals.

As shown, the memory 110 may have stored thereon instructions 112-120 that the processor 102 may fetch, decode, and execute. Particularly, the processor 102 may execute the instructions 112-120 to generate an index of vertical table columns and execute a query using the generated index based on a predicate included in the query. The instructions 112-120 may be non-transitory machine-readable instructions (or equivalently, non-transitory computer-readable instructions).

The processor 102 may fetch, decode, and execute the instructions 112 to receive parameters 202 for a partition range for a partition key 218 associated with a table 206. In some examples, the table 206 may be stored at the apparatus 100, at a server 204 connected to the apparatus 100 via a network, a data store 205 connected to the server 204, and/or the like. The table 206 may include vertical table columns 208 and rows 210. In some examples, the table 206 may have a vertical table structure, such as a columnar structure as previously described. In some examples, the table 206 may be the same as a super-projection 302 as depicted in FIG. 3, which may include columns C1 to Cn and rows R1 to Rm of a base table.

In some examples, the processor 102 may generate an index 304. The index 304 may include a subset of the vertical table columns C1 to Cn of the table 206. The index 304 may be optimized for a particular query. In some examples, the index 304 may be a non-super-projection that may include select columns among columns C1 to Cn of the super-projection 302, for instance, columns C1 and C2. The index 304 may be optimized for a particular query by —a selection of the columns C1 and C2 and/or a sort order of the selected columns C1 and C2. The index 304 may include all rows R1 to Rm associated with the table 206.

The processor 102 may fetch, decode, and execute the instructions 114 to generate an index 212 associated with the table 206. In some examples, the index 212 may be a physical store for a subset of data from the table 206. The index 212 may be a partition ranged index. The index 212 may be the same as the projection 306 depicted in FIG. 3.

In some examples, the index 212 may be optimized for a certain query. In this regard, the index 212 may include vertical table columns 214, which may be optimized for the query. The vertical table columns 214 included in the index 212 may be a subset of the vertical table columns 208 of the table 206. The vertical table columns 214 included in the index 212 may be sorted and/or segmented to optimize performance of the query.

In some examples, the processor 102 may generate the index 212 to include a subset of rows 216 based on the received parameters 202 for the partition range. The subset of rows 216 of the index 212 may be a subset of the rows 210 of the table 206 correlating to the partition range. The index 212 may have a partition key 218 associated with the table 206. The partition key 218 may have a predetermined format, such as a date/time based format, or the like, and may be used to define a partition range for the index 212.

By way of particular example and for purposes of illustration, the index 212 may be the same as the projection 306 depicted in FIG. 3. The projection 306 may include the optimized vertical table columns 214 including columns C1 and C2 and the subset of rows 216 including rows R1 to R3 of the super-projection 302. The projection 306 may include the partition key 218, which may be derived from a time based column of the super-projection 302, such as column C1. In some examples, based on the received parameters 202 for the partition range, the processor 102 may generate projection 306 to have rows R1 to R3 as the subset of rows 216 to be included in the projection 306. In this regard, the projection 306 may include the subset of the rows 216, R1 to R3, and the non-super-projection may have all of the rows of the super-projection 302, R1 to Rm.

In some examples, the received parameters 202 for the partition range may include a minimum value and a maximum value correlating to the partition range. By way of particular example, in a case where the partition key 218 is a date range, the minimum value may be a minimum date in the partition range, such as a value of “3/2/2021” as shown in row R1 of the projection 306, and the maximum value may be a maximum date in the partition range, such as a date that may be equal to or greater than a value of “6/3/2021” as shown in row R3 of the projection 306.

In some examples, the processor 102 may set a partition range as a dynamic expression that may depend on functions, such as a “now” function, that may produce a current date and/or time or a value correlated to the current date and/or time. By way of particular example and for purposes of illustration, the processor 102 may create the projection 306 based on an instruction:
create projection t_range as select*from t order by b on partition range between date_trunc(‘month’, now( ):: timestamp-interval′1 month′) and null′

When the processor 102 creates the projection 306 based on such an instruction, the static range may automatically be calculated based on the current date and/or time, and may be saved to the projection “object.” In this example, when the current system date when the projection is created is “04/10/2021”, the processor 102 may set the partition range of the projection to be between a minimum value of “03/01/2021” and a maximum value of unlimited, or null. As such, the processor 102 may include a subset of rows 216 in the projection 306 that includes rows R1, R2, and R3, each of which may have a date value for the partition key 218 that falls within the saved partition range. The processor 102 may save this static partition range to the projection, which may be used for various operations, such as for incoming queries.

In some examples, the processor 102 may receive updated parameters 202 for the partition range of the generated index 212, and may modify the partition range of the generated index 212 based on the updated parameters 202 for the partition range. The processor 102 may refresh the generated index 212 based on the modified partition range.

In some examples, when the date range is a rolling date range, the processor 102 may dynamically refresh the data in the generated index 212 with new data from the table 206 based on the rolling date range. Continuing with the example in which the partition range is set based on the current system date and/or time when the system date and/or time advances and the expression produces a new partition key, for instance, the new partition key is “05/01/2021”, the processor 102 may update the minimum value of the partition range to be “04/01/2021”. Based on the new partition range, the processor 102 may dynamically refresh the data in the generated index 212 with new data from the table 206 based on the rolling date range, particularly with data correlated with a new partition range between “04/01/2021” to null, or infinity. In some examples, the processor 102 may discard containers outside the new partition range, for instance, containers for partition “03/01/2021”.

In some examples, in order to generate the index 212, the processor 102 may generate metadata for the index 212, may retrieve data for the index 212 from the table 206 based on the generated metadata for the index 212, and may generate the index by populating the index 212 with the retrieved data for the index 212. The metadata for the index 212 may be a catalog for the index 212, which may define parameters of the index 212. The metadata for the index 212 may be metadata for the optimized vertical table columns 214 based on the received parameters 202 for the partition range, which may include a minimum value of the partition key 218 and a maximum value of the partition key 218 that may correlate to the partition range. In some examples, the retrieved data for the index 212 may include a subset of rows 216 of the table 206 correlating to the minimum value of the partition key 218 and the maximum value of the partition key 218.

In some examples, the processor 102 may validate the generated index 212 based on a format of the partition key 218, a value of the partition range of the partition key 218, a data type of index 212 or partition key 218, and/or a combination thereof. By way of particular example and for purposes of illustration, the processor 102 may validate a range of the partition key 218, for instance, that the minimum value of the partition key 218 is less than or equal to a maximum value of the partition key 218. In some examples, the processor 102 may validate whether a format of the partition key 218 is in an acceptable format, for instance, that the partition key 218 is a string literal such as “2021-01-01”, or an expression having a format that includes stable and/or immutable functions, such as “date_trunc(month′, now( ):: timestamp interval′1 month′)”, which may fold into a constant. In some examples, based on the validation of the generated index 212, the processor 102 may populate the generated index 212 using data from the table 206 for the subset of rows 216 of the table 206 correlating to the received parameters 202 for the partition range.

The processor 102 may fetch, decode, and execute the instructions 116 to receive a query 220 having a predicate 222 associated with the partition key 218 associated with the table 206. The processor 102 may fetch, decode, and execute the instructions 118 to determine whether the predicate 222 is within the partition range for the generated index 212. In some examples, based on the received query 220, the processor 102, or an optimizer (not shown), may identify indexes 304 among a plurality of indexes 304 of vertical table columns for the super-projection 302 that may be optimized for the received query 220. In this regard, the processor 102 may identify all indexes that may be optimized for the query 220 based on sort and segmentation of the indexes. In some examples, the identified indexes may include indexes that may not be partition ranged based on the partition key 218, such as the index 304, and indexes that may be partition ranged based on the partition key 218, such as the projection 306.

The generated index 212 may be one of the identified indexes. The processor 102 may remove, among the identified indexes, indexes in which a respective partition key is outside of the partition range for the predicate 222. In some examples, during local planning, when the processor 102 determines that an index included among the identified indexes is partition ranged, the processor 102 may select a super-projection 302 and may perform min/max pruning using the super-projection 302. In this case, when the processor 102 determines that a storage container that has not been pruned has a partition key outside a partition range for a particular index, then the processor 102 may determine that the table 206 contains data outside of that partition range, and as such, the processor 102 may exclude that particular index from being used for the query 220.

The processor 102 may fetch, decode, and execute the instructions 120 to execute the query 220 using the generated index 212 based on a determination that the predicate 222 included in the received query 220 is within the partition range for the generated index 212. In some examples, the processor 102 may generate an error when the processor 102 determines that a particular index 212 may not be used for the query 220. When the processor 102 generates an error, the processor 102 may trigger a retry, and may set an internal configuration flag to disable selection of the particular index associated with the generated error. In some examples, the processor 102 may not select any index 212 when such a configuration flag is set. In some examples, when a partition ranged projection 306 is not found for the query 220, the processor 102 may use a non-partition ranged projection 306 or the super-projection 302 to execute the query 220.

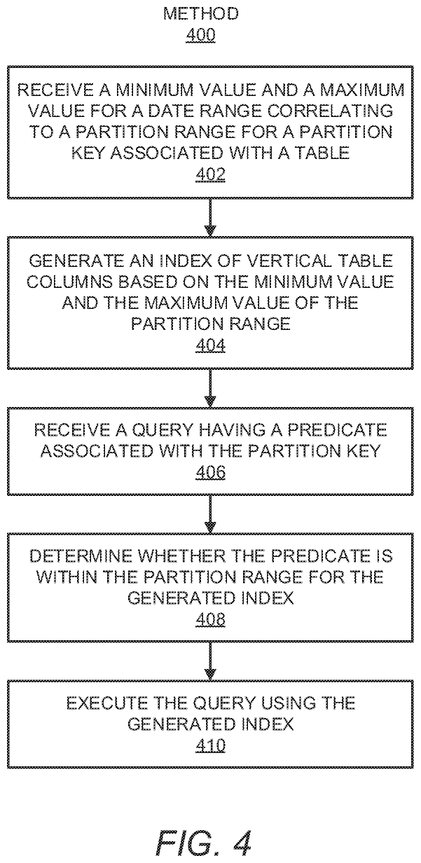

Various manners in which the processor 102 may operate are discussed in greater detail with respect to the method 400 depicted in FIG. 4. FIG. 4 depicts a flow diagram of an example method for generating an index 212 of vertical table columns based on a minimum value and a maximum value of a partition range for a partition key 218 associated with a table 206, receiving a query 220 having a predicate 222 associated with the partition key 218, and executing the query 220 using the generated index 212 based on the predicate 222 included in the query 220. It should be understood that the method 400 depicted in FIG. 4 may include additional operations and that some of the operations described therein may be removed and/or modified without departing from the scope of the method 400. The description of the method 400 is made with reference to the features depicted in FIGS. 1, 2, and 3 for purposes of illustration.

At block 402, the processor 102 may receive a minimum value and a maximum value for a date range correlating to a partition range for a partition key 218 associated with a table 206. In some examples, the table 206 may have a vertical table structure.

At block 404, the processor 102 may generate an index 212 of vertical table columns based on the minimum value and the maximum value of the partition range. The index 212 may be a physical store for data from the table 206 and may have a subset of rows 216 of rows 210 of the table 206 correlating to the partition range.

At block 406, the processor 102 may receive a query 220 that may have a predicate 222 associated with the partition key 218. At block 408, the processor 102 may determine whether the predicate 222 is within the partition range for the generated index 212. At block 410, based on a determination that the predicate 222 included in the query 220 is within the partition range for the generated index 212, the processor 102 may execute the query 220 using the generated index 212.

In some examples, the date range may be a rolling date range, and the processor 102 may dynamically refresh the data in the index 212 with new data from the table 206 based on the rolling date range. In some examples, the partition key 218 may be derived from a time based column of the table 206, for instance, a date column such as column C1 depicted in FIG. 3.

In some examples, the processor 102 may receive updated parameters 202 for the partition range of the index 212 and may modify the partition range of the index 212 based on updated parameters 202 for the partition range. The processor 102 may refresh the index 212 based on the modified partition range.

In some examples, the processor 102 may generate metadata for the index 212 of vertical table columns based on the minimum value and the maximum value for the date range correlating to the partition range. The processor 102 may retrieve, from the table 206, data for the index 212 based on the generated metadata for the index 212. The processor 102 may generate the index 212 by populating the index 212 with the retrieved data correlating to the partition range. In some examples, the retrieved data for the index 212 may include a subset of rows 216 of the table 206 correlating to the minimum value and the maximum value for the date range.

In some examples, the processor 102 may validate the generated index 212 based on a format of the partition key 218, a value of the partition range of the partition key 218, a data type of index 212 or the partition key 218, and/or a combination thereof. Based on the validation of the generated index 212, the processor 102 may populate the generated index 212 using data from the table 206 for the subset of rows 216 of the table 206 correlating to the partition range.

The processor 102 may identify indexes among a plurality of indexes of vertical table columns for the table 206 that may be optimized for the received query 220 based on the received query 220. The identified indexes may include indexes which may not be partition ranged, such as the index 304, and indexes which may be partition ranged, such as the projection 306. The processor 102 may remove, among the identified indexes, indexes in which a respective partition key may be outside the partition range. In some examples, the generated index 212 may be among remaining ones of the identified indexes.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic apparatus capable of executing the above-described functions may perform those functions enumerated above.

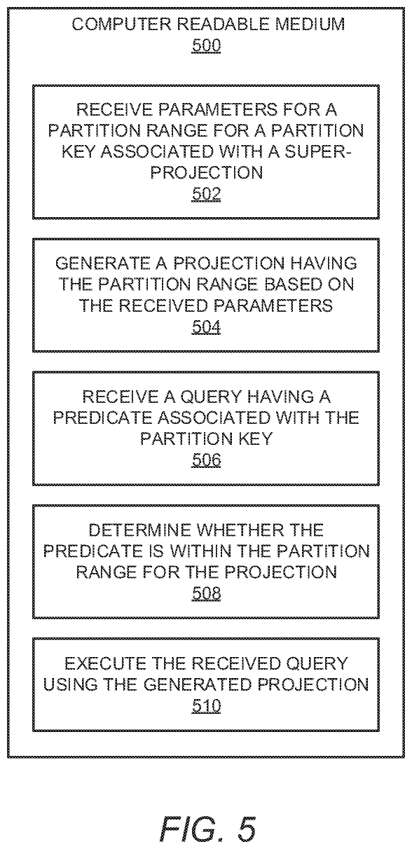

Turning now to FIG. 5, there is shown a block diagram of an example non-transitory computer-readable medium 500 that may have stored thereon machine readable instructions to generate a projection 306 having a partition range, receive a query 220 having a predicate 222 associated with a partition key 218, and execute the received query 220 using the generated projection 306 based on the predicate 222 included in the received query 220. It should be understood that the computer-readable medium 500 depicted in FIG. 5 may include additional instructions and that some of the instructions described herein may be removed and/or modified without departing from the scope of the computer-readable medium 500 disclosed herein. The computer-readable medium 500 may be a non-transitory computer-readable medium. The term “non-transitory” does not encompass transitory propagating signals. The description of the non-transitory computer-readable medium 500 is also made with reference to the features depicted in FIGS. 1, 2, and 3 for purposes of illustration. Particularly; the processor 102 of the apparatus 100 may execute some or all of the instructions 502-510 included in the non-transitory computer-readable medium 500.

The computer-readable medium 500 may have stored thereon machine-readable instructions 502-510 that a processor, such as the processor 102 depicted in FIGS. 1 and 2, may execute. The computer-readable medium 500 may be an electronic, magnetic, optical, or other physical storage device that contains or stores executable instructions. The computer-readable medium 500 may be, for example, RAM, EEPROM, a storage device, an optical disc, or the like.

The processor may fetch, decode, and execute the instructions 502 to receive parameters 202 for a partition range for a partition key 218 associated with a super-projection 302. The super-projection 302 may have a vertical table structure.

The processor may fetch, decode, and execute the instructions 504 to generate a projection 306 that may have the partition range based on the received parameters 202. The projection 306 may be the same as the index 212 depicted in FIG. 2. In some examples, the projection 306 may be a physical store for data from the super-projection 302 and may have a subset of rows 216 of the super-projection 302 correlating to the partition range.

The processor may fetch, decode, and execute the instructions 506 to receive a query 220 that may have a predicate 222 associated with the partition key 218. The processor may fetch, decode, and execute the instructions 508 to determine whether the predicate 222 is within the partition range for the projection 306.

Based on a determination that the predicate 222 included in the received query 220 is within the partition range for the projection 306, the processor may fetch, decode, and execute the instructions 510 to execute the received query 220 using the generated projection 306.

In some examples, the received parameters 202 for the partition range may include a minimum value and a maximum value for a date range correlating to the partition range. In some examples, the minimum value may be set based on a current date/time function and the maximum value may be set to be null, or infinity. The processor 102 may dynamically scroll the partition range based on the changing values of the minimum value.

In some examples, the processor may generate a catalog of metadata for the projection 306 based on the received parameters 202 for the partition range. The received parameters 202 may include a minimum value of the partition key 218 and a maximum value of the partition key 218 that may correlate to the partition range. The processor may retrieve, from the super-projection 302, data for the projection 306 based on the catalog of metadata for the projection 306. The processor may generate the projection 306 by populating the projection 306 with the retrieved data correlating to the partition range. In some examples, the retrieved data for the projection 306 may include a subset of rows 216 of the super-projection 302 correlating to the minimum value of the partition key 218 and the maximum value of the partition key 218.

In some examples, the processor may validate the generated projection 306 based on a format of the partition key 218, a value of the partition range of the partition key 218, a data type of generated projection 306 or the partition key 218, and/or a combination thereof. Based on the validation of the generated projection 306, the processor may populate the projection 306 using data from the super-projection 302 for the subset of rows 216 of the super-projection 302 correlating to the received parameters 202 for the partition range.

In some examples, based on the received query 220, the processor may identify projections among the plurality of projections associated with the super-projection 302 that may be optimized for the received query 220. The identified projections may include non-partition ranged projections, such as the projection 306, and may include partition ranged projections, such as the projection 306. The processor may remove, among the identified projections, projections in which a respective partition key is outside the partition range. In some examples, the generated projection 306 may be a projection among remaining ones of the identified projections.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which are stored machine-readable instructions that when executed by the processor, cause the processor to:
receive parameters for a partition range for a partition key associated with a table, the table having a vertical table structure;
generate an index of vertical table columns based on the received parameters for the partition range, the generated index being a physical store for data from the table and having a subset of rows of the table correlating to the partition range;
receive a query having a predicate associated with the partition key associated with the table;
determine whether the predicate is within the partition range for the generated index; and
based on a determination that the predicate included in the received query is within the partition range for the generated index, execute the query using the generated index.

2. The apparatus of claim 1, wherein the received parameters for the partition range include a minimum value and a maximum value for a date range correlating to the partition range.

3. The apparatus of claim 2, wherein the date range is a rolling date range, and wherein the instructions further cause the processor to:
dynamically refresh the data in the generated index with new data from the table based on the rolling date range.

4. The apparatus of claim 2, wherein the partition key is derived from a time based column of the table.

5. The apparatus of claim 1, further comprising:
receive updated parameters for the partition range of the generated index;
modify the partition range of the generated index based on the updated parameters for the partition range; and
refresh the generated index based on the modified partition range.

6. The apparatus of claim 1, further comprising:
generate metadata for the index of vertical table columns based on the received parameters for the partition range, the received parameters comprising a minimum value of the partition key and a maximum value of the partition key that correlate to the partition range;
retrieve, from the table, data for the index based on the generated metadata for the index; and
generate the index by populating the index with the retrieved data correlating to the partition range, the retrieved data for the index comprising a subset of rows of the table correlating to the minimum value of the partition key and the maximum value of the partition key.

7. The apparatus of claim 1, further comprising:
validate the generated index based on a format of the partition key, a value of the partition range of the partition key, a data type of index, and/or a combination thereof; and
based on the validation of the generated index, populate the generated index using data from the table for the subset of rows of the table correlating to the received parameters for the partition range.

8. The apparatus of claim 1, further comprising:
based on the received query, identify indexes among a plurality of indexes of vertical table columns for the table that are optimized for the received query; and
remove, among the identified indexes, indexes in which a respective partition key is outside of the partition range, wherein the generated index is among remaining ones of the identified indexes.

9. A method comprising:
receiving, by a processor, a minimum value and a maximum value for a date range correlating to a partition range for a partition key associated with a table, the table having a vertical table structure;
generating, by the processor, an index of vertical table columns based on the minimum value and the maximum value of the partition range, the index being a physical store for data from the table and having a subset of rows of the table correlating to the partition range;
receiving, by the processor, a query having a predicate associated with the partition key;
determining, by the processor, whether the predicate is within the partition range for the generated index; and
based on a determination that the predicate included in the query is within the partition range for the generated index, executing, by the processor, the query using the generated index.

10. The method of claim 9, wherein the date range is a rolling date range, the method further comprising:
dynamically refreshing the data in the index with new data from the table based on the rolling date range.

11. The method of claim 10, wherein the partition key is derived from a time based column of the table.

12. The method of claim 10, further comprising:
receiving updated parameters for the partition range of the index;
modifying the partition range of the index based on updated parameters for the partition range; and
refreshing the index based on the modified partition range.

13. The method of claim 9, further comprising:
generating metadata for the index of vertical table columns based on the minimum value and the maximum value for the date range correlating to the partition range;
retrieving, from the table, data for the index based on the generated metadata for the index; and
generating the index by populating the index with the retrieved data correlating to the partition range, the retrieved data for the index comprising a subset of rows of the table correlating to the minimum value and the maximum value for the date range.

14. The method of claim 9, further comprising:
validating the generated index based on a format of the partition key, a value of the partition range of the partition key, a data type of index, and/or a combination thereof; and
based on the validation of the generated index, populating the generated index using data from the table for the subset of rows of the table correlating to the partition range.

15. The method of claim 9, further comprising:
based on the received query, identifying indexes among a plurality of indexes of vertical table columns for the table that are optimized for the received query; and
removing, among the identified indexes, indexes in which a respective partition key is outside the partition range, wherein the generated index is among remaining ones of the identified indexes.

16. A non-transitory computer-readable medium on which is stored machine-readable instructions that, when executed by a processor, cause the processor to:
receive parameters for a partition range for a partition key associated with a super-projection, the super-projection having a vertical table structure;
generate a projection having the partition range based on the received parameters, the projection being a physical store for data from the super-projection and having a subset of rows of the super-projection correlating to the partition range;
receive a query having a predicate associated with the partition key;
determine whether the predicate is within the partition range for the projection; and
based on a determination that the predicate included in the received query is within the partition range for the projection, execute the received query using the generated projection.

17. The non-transitory computer-readable medium of claim 16, wherein the received parameters for the partition range include a minimum value and a maximum value for a date range correlating to the partition range.

18. The non-transitory computer-readable medium of claim 16, wherein the instructions further cause the processor to:
generate a catalog of metadata for the projection based on the received parameters for the partition range, the received parameters comprising a minimum value of the partition key and a maximum value of the partition key that correlates to the partition range;
retrieve, from the table, data for the projection based on the catalog of metadata for the projection; and
generate the projection by populating the projection with the retrieved data correlating to the partition range, the retrieved data for the projection comprising a subset of rows of the super-projection correlating to the minimum value of the partition key and the maximum value of the partition key.

19. The non-transitory computer-readable medium of claim 16, wherein the instructions further cause the processor to:
validate the generated projection based on a format of the partition key, a value of the partition range of the partition key, a data type of generated projection, and/or a combination thereof; and
based on the validation of the generated projection, populate the projection using data from the super-projection for the subset of rows of the super-projection correlating to the received parameters for the partition range.

20. The non-transitory computer-readable medium of claim 16, wherein the instructions further cause the processor to:
based on the received query, identify projections among the plurality of projections associated with the super-projection that are optimized for the received query; and
remove, among the identified projections, projections in which a respective partition key is outside the partition range, wherein the generated projection is among remaining ones of the identified projections.
